(19) United States
(12) Patent Application Publication
(10) Pub. No.: US 2005/0161629 A1
(43) Pub. Date: Jul. 28, 2005

(54) Throttle body

(75) Inventor: Thomas Hannewald, Griesheim (DE)

Correspondence Address: SIEMENS SCHWEIZ;I-44, INTELLECTUAL PROPERTY, ALBISRIEDERSTRASSE 245, ZURICH, CH-8047, CH

(73) Assignee: SIEMENS AKTIENGESELLSCHAFT, MUNICH (DE)

(21) Appl. No.: 11/085,146

(22) Filed: Mar. 22, 2005

Related U.S. Application Data
(63) Continuation of application No. PCT/EP04/52225, filed on Sep. 17, 2004.

(30) Foreign Application Priority Data
Oct. 20, 2003 (DE) 103 49 265.8

(51) Int. Cl. F16K 3/36; F16K 5/22; F16K 11/00; F16K 51/00; F16K 1/22

(52) U.S. Cl. 251/308

(57) ABSTRACT

The throttle body has a tubular housing (1a, 1b), in which a throttle valve (2) is secured, perpendicular with respect to the direction of flow in the tubular housing (1a, 1b), on a throttle shaft (3) arranged perpendicular with respect to the direction of flow in the tubular housing (1a, 1b), the throttle shaft (3) being mounted rotatably on one side on a bearing (5) arranged adjacent to the actuator (6), and the throttle valve (2) having, on its outer edge, a peripheral seal (4) which has a gap (4′) only in the region of the bearing (5).

The invention relates to a throttle body. Throttle bodies are known. DE 195 12 874 A1 describes a throttle body which has a tubular housing. The throttle valve in the interior of this housing is secured here on a throttle shaft, which is mounted in a manner such that it leads at its free ends transversely with respect to the longitudinal axis of the tubular housing through recesses in the housing wall and such that it can rotate in two bearings. In the closed state, the throttle valve separates the housing into a suction side and into a side in which ambient pressure prevails. A disadvantage of this known throttle body is that the negative pressure present in the suction side makes it possible for a relatively large amount of leakage air to pass via the bearings of the throttle shaft and via the edge of the throttle valve into the suction side, which is not desirable.

The invention is therefore based on the object of providing a throttle body enabling the disadvantageous flow of leakage air to the suction side of the air duct to be largely avoided.

The object on which the invention is based is achieved by a throttle body having a tubular housing, in which a throttle valve is secured, perpendicular with respect to the direction of flow in the tubular housing, on a throttle shaft arranged perpendicular with respect to the direction of flow in the tubular housing, the throttle shaft being mounted rotatably on one side on a bearing arranged adjacent to the actuator, and the throttle valve having, on its outer edge, a peripheral seal which has a gap only in the region of the bearing.

The tubular housing is generally designed in two parts and particularly advantageously consists of aluminum. The throttle valve can be secured on the throttle shaft by means of screwing or by means of bonding, for example. The throttle shaft is mounted rotatably on one side on a bearing arranged adjacent to the actuator. A mounting means is therefore provided only at one end of the throttle shaft. The peripheral seal has a gap only in the region of the bearing, said gap being used to let the throttle shaft through to the bearing. In the closed state, the seal bears flush against the tubular housing of the throttle body.

It has surprisingly been shown that with the throttle body a disadvantageous flow of leakage air to the suction side of the air duct in the tubular housing is virtually completely avoided. Since the throttle shaft is mounted only on one side in the housing, the peripheral seal is interrupted only by a single gap in the region of the bearing, which virtually completely prevents leakage air from flowing in. In addition, it is advantageous that a peripheral seal can also be arranged without tilting the throttle valve, with that end of the throttle shaft which is mounted on one side being positioned in the gap of the peripheral seal. It is also disadvantageous that the housing does not require any changes whatsoever in order to avoid the inflow of leakage air. The throttle valve is of relatively simple design in terms of structure and can therefore be manufactured at reasonable cost. The arrangement of the peripheral seal is simple and easy to install, thus advantageously assisting series production.

One preferred refinement of the invention is for the throttle valve to have, on its outer edge, a peripheral groove in which the peripheral seal is arranged, It is advantageous in this case for the peripheral seal to be able to be held in a form-fitting manner in the peripheral groove, with additional securing means being dispensed with.

According to a further refinement of the invention, provision is made for a flat metal ring to be arranged as the peripheral seal. Said metal ring can be placed in a particularly simple manner into the peripheral groove of the throttle valve, which simplifies and reinforces the leakproof sealing off of the suction side of the air duct to a particular extent.

According to a further refinement of the invention, a plastic tolerance ring is arranged as the peripheral seal. In this case, the plastic tolerance ring may also consist, for example, of polytetrafluoroethylene. It is generally designed as a flat ring and has a continuous gap. When the suction side of the air duct is sealed off, the outside of the tolerance ring is pressed against the air duct, thus reducing or completely eliminating the gap. The stress arising as a result in the tolerance ring additionally presses the tolerance ring against the inner wall of the air duct which is formed by the tubular housing, this reinforcing the leakproof sealing off with respect to the suction side of the air duct.

A further preferred refinement of the invention involves the throttle valve having, centrally, a sleeve section which is designed on the inside in a complementary manner to the throttle shaft. In this case, it is advantageous for the throttle shaft to be able to be placed into the sleeve section and to be able to be fixed solely by means of a frictional connection. Additional securing means, for example screws or rivets, can advantageously be dispensed with here.

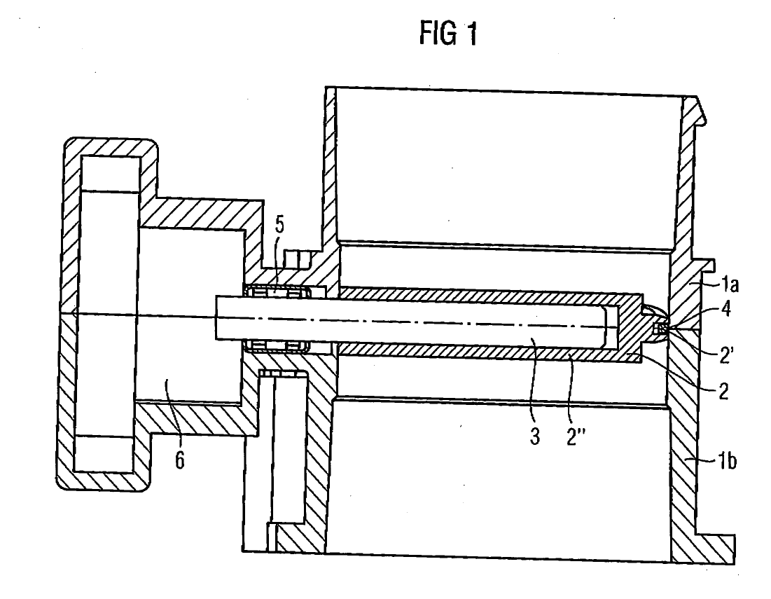

The invention is explained in more detail and by way of example below with reference to the drawings (FIG. 1 to FIG. 3).

FIG. 1 shows the throttle body in longitudinal section.

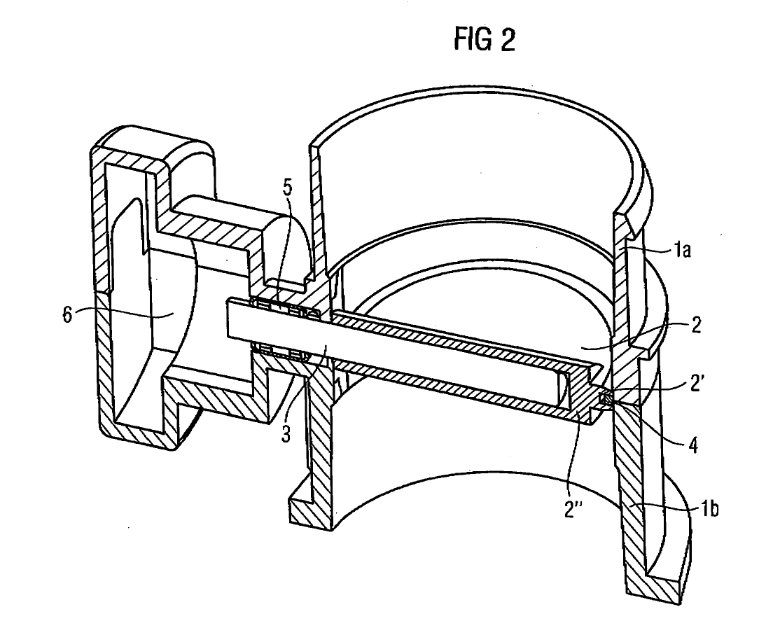

FIG. 2 shows the throttle body in longitudinal section in a three-dimensional form.

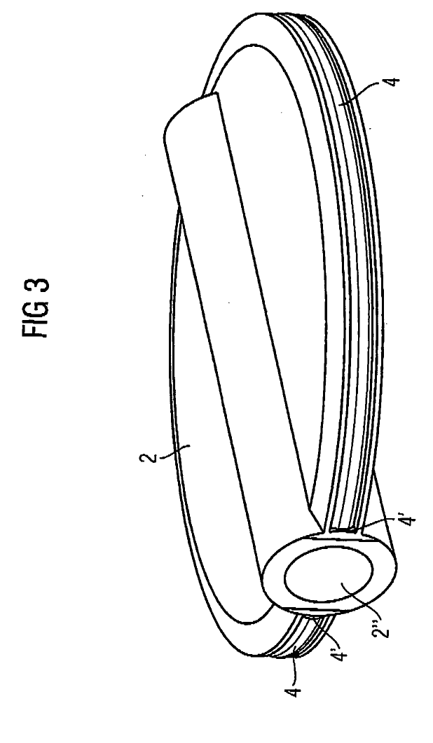

FIG. 3 shows a perspective view of the throttle valve with a sleeve section and a peripheral seal.

FIG. 1 illustrates the throttle body in longitudinal section. It has a tubular housing 1a, 1b which is designed in two parts. In the tubular housing 1a, 1b, a throttle valve 2 is secured, perpendicular with respect to the direction of flow in the tubular housing 1a, 1b, on a throttle shaft 3 arranged perpendicular with respect to the direction of flow in the tubular housing 1a, 1b. The throttle shaft 3 is mounted rotatably on one side on a bearing 5 arranged adjacent to the actuator 6. The actuator 6 is illustrated merely schematically and in simplified form. The actuator 6 sets the throttle shaft 3 into a rotational movement. On its outer edge, the throttle valve 2 has a peripheral seal 4 which has a gap (not illustrated) only in the region of the bearing 5. In this case, the peripheral seal 4 is arranged in a peripheral groove 2′ of the throttle valve 2. In a particularly advantageous manner, the peripheral seal 4 can be arranged as a flat metal ring. A further preferred refinement of the peripheral seal 4 resides in the arrangement of a plastic tolerance ring. The throttle valve 2 has, centrally, a sleeve section 2″ which is designed on the inside in a complementary manner to the throttle shaft 3. In this case, it is advantageous that the throttle valve 2 can be pushed in a relatively simple manner onto the throttle shaft 3 and can be fixed frictionally, so that no further securing means are required.

FIG. 2 is a three-dimensional illustration of the throttle body in longitudinal section. The illustration of the individual parts of the actuator 6 has also been omitted in FIG. 2 for clarity reasons.

FIG. 3 is a three-dimensional illustration of the throttle valve 2. It has a sleeve section 2″ for receiving the throttle shaft (not illustrated). A peripheral seal 4, which has a gap 4′ only in the region of the bearing (not illustrated), is arranged in the peripheral groove (not illustrated) of the throttle valve 2. In this case, the peripheral seal 4 is designed in terms of structure in such a manner that it minimizes the gap 4′ when the air duct of the tubular housing (not illustrated) is sealed off. A relatively high sealing action is thereby obtained.

1. A throttle body having a tubular housing in which a throttle valve is secured, substantially perpendicular with respect to the direction of flow in the tubular housing, on a throttle shaft arranged substantially perpendicular with respect to the direction of flow in the tubular housing, the throttle shaft being mounted rotatably on one side on a bearing arranged adjacent to the actuator, and the throttle valve having, on its outer edge, a peripheral seal which has a gap only in the region of the bearing.

2. The throttle body as according to claim 1, in which the throttle valve has, on its outer edge, a peripheral groove in which the peripheral seal is arranged.

3. The throttle body according to claim 2, in which a flat metal ring is arranged as the peripheral seal.

4. The throttle body according to claim 2, in which a plastic tolerance ring is arranged as the peripheral seal.

5. The throttle body according to claim 1, in which the throttle valve has, centrally, a sleeve section which is designed on the inside in a complementary manner to the throttle shaft.
